(19) United States
(12) Patent Application Publication
(10) Pub. No.: US 2016/0180593 A1
(43) Pub. Date: Jun. 23, 2016

(54) WEARABLE DEVICE-BASED AUGMENTED REALITY METHOD AND SYSTEM

(71) Applicant: HUIZHOU TCL MOBILE COMMUNICATION CO., LTD., Guangdong (CN)

(72) Inventor: Yan Yang, HUIZHOU (CN)

(21) Appl. No.: 14/893,646

(22) PCT Filed: Aug. 29, 2014
(86) PCT No.: PCT/CN2014/085752

§ 371 Date: Nov. 24, 2015

(30) Foreign Application Priority Data
Jul. 2, 2014 (CN) 201410315615.3

(51) Int. Cl. G06T 19/00; G06T 17/00

(52) U.S. Cl. CPC G06T 19/006; G06T 17/00; G06T 2200/08; G06T 2200/04; G06T 2215/16; G06T 2219/2008

(57) ABSTRACT

A wearable device-based augmented reality method and system may include taking pictures of an object to be virtualized via a wearable device from a plurality of angles and, according to the pictures from a plurality of angles, constructing a 3D virtual model of the object to be virtualized. The 3D virtual model may include an initial profile dimension. The method and system may also include modifying the initial profile dimension of the 3D virtual model to obtain a target profile dimension of the 3D virtual model, overlaying a 3D virtual model having the target profile dimension to a selected real scenario to obtain a virtual and real integrated image. Thereby, a user may modify a dimension of a 3D virtual model according to personal preferences, and may better overlay the modified 3D virtual model onto a real scenario.

### TECHNICAL

The present disclosure relates to the field of 3D augmented reality technologies. In particular, the present disclosure relates to a wearable device-based augmented reality method and system.

### BACKGROUND

Augmented Reality (AR or mixed reality) is a new technology developed on the basis of virtual reality, which applies virtual information into the real world through computer technologies. Thereby, a real scenario and an object may be overlaid and virtualized in real time to a picture or space of the same image. As a result, augmented reality can not only display information of the real world, but also can display virtual information at the same time. The two types of information complement each other and are overlaid.

Currently, a shooting device typically marks an object to be virtualized (taken), obtains the virtual information of the object, and consequently obtains a corresponding 3D virtual model. The 3D virtual model then overlays with computer graphs of the real scenario to achieve Augmented Reality. However, the operations to mark the object to be virtualized are not convenient and are expensive, leading to a relatively high cost of Augmented Reality. Moreover, it is not easy to change a size of a 3D virtual model of an object to be virtualized in overlaying operations, and it is impossible to achieve good overlaying according to the size of the real scenario, leading to a poor effect of Augmented Reality.

### SUMMARY

Technical problems to be solved by examples of the present invention provide a wearable device-based augmented reality method and system, which can better overlay a virtual object according to a size of a real scenario, improve the effect of Augmented Reality, and have a relatively low cost.

A wearable device-based augmented reality method includes taking pictures of an object to be virtualized via a wearable device from a plurality of angles; according to the pictures from a plurality of angles; constructing a 3D virtual model of the object to be virtualized, wherein the 3D virtual model includes an initial profile dimension; modifying the initial profile dimension of the 3D virtual model to obtain a target profile dimension of the 3D virtual model; overlaying the 3D virtual model having the target profile dimension to a selected real scenario to obtain a virtual and real integrated image, wherein a plurality of real scenarios to be selected are displayed in a thumbnail format for selection; providing a preview option and a saving option; when the preview option is selected, displaying a current virtual and real integrated image in real time; and when the saving option is selected, saving the current virtual and real integrated image.

In another embodiment, modifying an initial profile dimension of a 3D virtual model includes selecting a similar point of pictures from a plurality of angles, and obtaining real dimension of an object to be virtualized by simultaneously considering depth parameters of the pictures from a plurality of angles; modifying the initial profile dimension of the 3D virtual model according to the real dimension.

In a further embodiment, modifying an initial profile dimension of the 3D virtual model includes selecting, through a preset database, a corresponding 3D virtual model of an object to be virtualized in the database; modifying the initial profile dimension of a constructed 3D virtual model according to the dimension of the selected 3D virtual model in the database.

In yet another embodiment, a wearable device-based augmented reality method includes taking pictures of an object to be virtualized via a wearable device from a plurality of angles; according to the pictures from a plurality of angles, constructing a 3D virtual model of the object to be virtualized, wherein the 3D virtual model includes an initial profile dimension; modifying the initial profile dimension of the 3D virtual model to obtain a target profile dimension of the 3D virtual model; and overlaying a 3D virtual model having the target profile dimension to a selected real scenario to obtain a virtual and real integrated image.

In yet a further embodiment, an augmented reality method includes displaying a plurality of real scenarios to be selected in a thumbnail format.

In another embodiment, an augmented reality method includes providing a preview option and a saving option; when the preview option is selected, displaying a current virtual and real integrated image in real time; when the saving option is selected, saving the current virtual and real integrated image.

In a further embodiment, an augmented reality system includes a wearable device and a construction terminal, wherein the wearable device includes a shooting module and a transmission module, and wherein the construction terminal includes a receiving module, a processing module and a display module, wherein: the shooting module is configured to take pictures of an object to be virtualized from a plurality of angles, and the transmission module is configured to transmit the pictures from a plurality of angles to the receiving module; the processing module is configured to construct a 3D virtual model of the object to be virtualized according to the pictures from a plurality of angles received by the receiving module, wherein the 3D virtual model includes an initial profile dimension; and the processing module is further configured to modify the initial profile dimension of the 3D virtual model to obtain a target profile dimension of the 3D virtual model, to overlay a 3D virtual model having the target profile dimension to a selected real scenario to obtain a virtual and real integrated image, and further to control the display module to display the virtual and real integrated image.

In yet another embodiment, a processing module is configured to select a similar point of pictures from a plurality of angles, obtain a real dimension of an object to be virtualized by simultaneously considering depth parameters of the pictures from a plurality of angles, and modify an initial profile dimension of a 3D virtual model according to the real dimension.

In yet a further embodiment, a processing module is configured to select, through a preset database, a corresponding 3D virtual model of an object to be virtualized in the database, and modify an initial profile dimension of a constructed 3D virtual model according to the dimension of the selected 3D virtual model in the database.

In another embodiment, a processing module is further configured to control a display module to display a plurality of real scenarios to be selected in a thumbnail format.

In a further embodiment, a processing module is further configured to provide a preview option and a saving option, such that, when the preview option is selected, control a display module to display a current virtual and real integrated image in real time, and when the saving option is selected, save the current virtual and real integrated image.

With the above technical solutions, the advantageous effects of the present invention are as follows: taking pictures of an object to be virtualized via a wearable device from a plurality of angles, based on which a 3D virtual model of the object to be virtualized is constructed, then modifying the initial profile dimension of the 3D virtual model to obtain a target profile dimension, and lastly, overlaying the 3D virtual model having the target profile dimension to a selected real scenario. As a result, a user is able to freely and conveniently modify a dimension of a 3D virtual model according to personal preferences, and better overlay it onto a real scenario, which subsequently improves an effect of Augmented Reality and has a relatively low cost. Moreover, the use of a wearable device, to take pictures to construct a 3D virtual model of an object to be virtualized, results in easy operations and facilitates promotion of the use thereof.

### BRIEF DESCRIPTION OF THE DRAWINGS

FIG. 1 depicts a flow chart of an example augmented reality method according to the present invention; and

FIG. 2 depicts a block diagram of an example augmented reality system according to the present invention.

### DETAILED DESCRIPTION

Technical solutions of the present invention are described below with reference to the accompanying drawings. The examples described below are for illustrative purposes.

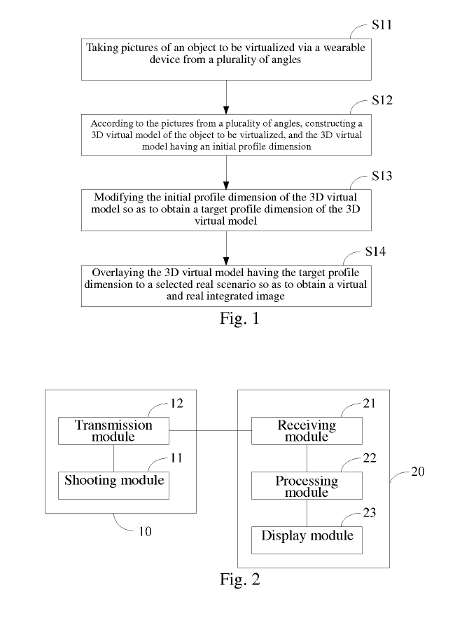

Turning to FIG. 1, a flow chart of an augmented reality method may include taking pictures of an object to be virtualized, via a wearable device, from a plurality of angles (block S11). Taking pictures of an object to be virtualized, via a wearable device, from a plurality of angles, and during the shooting process, may include focusing a lens of the wearable device on the object to be virtualized to obtain pictures from a plurality of angles.

Alternatively, the method may include taking a video of an object to be virtualized, via a wearable device, from a plurality of angles, and during the video-shooting process, focusing the lens of the wearable device on the object to be virtualized. A screenshot may then be captured from the obtained video, and thus obtaining pictures from a plurality of angles. The plurality of angles, selected for taking the pictures or video, may ensure that the obtained images are capable of presenting a 360-degree panoramic view of the object to be virtualized. In addition, specific shooting movements of the wearable device may be controlled in real time via other terminals (e.g. the construction terminal mentioned herein). For example, the specific shooting movements may be controlled by displaying in real time angles and scenarios that the wearable device can shoot via a tablet, cell phone or laptop. Accordingly, a user may carry out control according to the real time angle of the wearable device so as to capture optimal pictures. In other examples, a continuous video may be taken via a wearable device, and then other terminals may be used to perform capturing and processing on video angles therein to capture the optimal pictures.

The wearable device may be a smart bracelet, as an example, or may be any terminal capable of taking pictures or videos, including a smart watch, smart glasses and embedded devices in jewelry and clothing accessories, or electronic devices having camera and information transmission functions. A connection between the wearable device and other terminals may be wireless, including near field communication, Bluetooth, etc. According to the pictures from a plurality of angles, a 3D virtual model of the object may be constructed to be virtualized, and the 3D virtual model may include an initial profile dimension (block S12).

Selecting a similar point of the pictures from a plurality of angles, and constructing a 3D virtual model of the object to be virtualized may include simultaneously considering depth parameters and depth of focus information of the pictures from a plurality of angles, selecting a plurality of points of the object to be virtualized that can reflect its profile features, and employing a digital reconstruction technology. It should be noted that the dimension of the 3D virtual model may be obtained through the construction, i.e. the initial profile dimension, corresponds to the dimension of the object to be virtualized on the plurality of pictures. The augmented reality method may further include modifying the initial profile dimension of the 3D virtual model to obtain a target profile dimension of the 3D virtual model (block S13).

The 3D virtual model, having an initial profile dimension, may not necessarily be the model desired by the user, or the virtual and real integrated image obtained by overlaying it to a selected real scenario may not make the user satisfied. Therefore, it may be desirable to modify the initial profile dimension according to (the dimension of) the selected real scenario. The initial profile dimension of the 3D virtual model may be modified by selecting a similar point of the pictures from a plurality of angles, obtain a real dimension of the object to be virtualized by simultaneously considering depth parameters and depth of focus information of the pictures from a plurality of angles and through computer modulus analysis, and then modify the initial profile dimension according to the real dimension.

Alternatively, the initial profile dimension of the 3D virtual model may be modified by selecting, through a preset database, a corresponding 3D virtual model of the object to be virtualized in the database, and a corresponding dimension for every 3D virtual model may be pre-stored in the database. Subsequently, the initial profile dimension of the constructed 3D virtual model may be modified according to the dimension of the selected 3D virtual model in the database. The augmented reality method may also include overlaying the 3D virtual model having the target profile dimension to a selected real scenario to obtain a virtual and real integrated image. A plurality of real scenarios to be selected may be displayed in a thumbnail format on a display of a terminal for constructing the 3D virtual model.

It should be noted that, after the 3D virtual model having the target profile dimension is selected using a real scenario, the dimension of the 3D virtual model can still be modified. For example, the above modification methods may be used for modification until the user is satisfied and confirms the operation. The terminal, configured to construct the 3D virtual model, may further provide a preview option and a saving option. When a user selects the preview option, the display may display a current virtual and real integrated image in real time. When the user selects the saving option, the terminal may save the current virtual and real integrated image for observation, or for the user to subsequently make further modifications.

Based on the above augmented reality method, a user may be enabled to freely and conveniently modify at least one dimension of a 3D virtual model according to personal preferences. Thereby, the 3D virtual model may better overlay onto a real scenario, which may improve an effect of Augmented Reality and may have a relatively low cost. Moreover, use of a wearable device to take pictures to construct a 3D virtual model of an object to be virtualized may result in easy operations, may be fashionable, and may facilitate promotion of the use thereof. For example, the augmented reality method can be used in modeling, interior design, decoration or shooting of scenarios with 3D simulation effect. The user may acquire a shape of an object via a portable terminal such as a wearable device with camera functions and a portable communication terminal. The shape of the object may be input and placed into a corresponding real scenario with an accurate dimension, thereby providing simulated perceptual effects desired by a user, as if personally on the scene. During a decoration process, for example, whether the furnishings or decorative effect is desired by a user can be represented by placing simulated furniture (i.e. the 3D virtual model) with a corresponding dimension in a 3D graph of a room (i.e. the real scenario) in advance. The augmented reality method may also be used to take fun pictures to meet user demand and achieve better simulation effects.

With reference to FIG. 2, a block diagram of an augmented reality system may include a wearable device 10 and a construction terminal 20. The wearable device 10 may include a shooting module 11 and a transmission module 12. The construction terminal 20 may include a receiving module 21, a processing module 22 and a display module 23.

The shooting module 11 may be configured to take pictures of an object to be virtualized from a plurality of angles. The plurality of angles selected for taking the pictures or video may ensure that the obtained images are capable of presenting a 360-degree panoramic view of the object to be virtualized. The transmission module 12 may be configured to transmit the pictures, taken by the shooting module 11 from a plurality of angles, to the receiving module 21 of the construction terminal 20.

The processing module 22 may be configured to construct a 3D virtual model of the object to be virtualized according to the pictures from a plurality of angles received by the receiving module 21. The 3D virtual model may include an initial profile dimension. The processing module 22 may be configured to modify the initial profile dimension of the 3D virtual model to obtain a target profile dimension of the 3D virtual model. The processing module 22 may select a similar point of the pictures from a plurality of angles, may obtain a real dimension of the object to be virtualized by simultaneously considering depth parameters of the pictures from a plurality of angles, and may modify the initial profile dimension of the 3D virtual model according to the real dimension. Alternatively, the processing module 22 may select, through a preset database, a corresponding 3D virtual model of the object to be virtualized in the database, and may modify the initial profile dimension of the constructed 3D virtual model according to the dimension of the selected 3D virtual model in the database. Furthermore, the processing module 22 may be configured to overlay the 3D virtual model having the target profile dimension to a selected real scenario to obtain a virtual and real integrated image, and to control the display module 23 to display the virtual and real integrated image.

In a real application scenario, the processing module 22 may control the display module 23 to display a plurality of real scenarios to be selected in a thumbnail format, and may overlay the 3D virtual model having the target profile dimension to a selected real scenario based on a selection made by the user. After the virtual and real integrated image is obtained through overlying, the processing module 22 may be further configured to provide a preview option and a saving option, such that, when a user selects the preview option, the display module 23 may be controlled to display a current virtual and real integrated image in real time. When the user selects the saving option, the current virtual and real integrated image may be saved into the memory of the construction terminal 20.

The shooting module 11 and the transmission module 12 of the wearable device 10, as well as the receiving module 21, the processing module 22 and the display module 23 of the construction terminal 20, may correspondingly carry out the augmented reality method described above. Therefore, the augmented reality system may include the same technical effects as described above with respect to the augmented reality method.

It should be understood that the augmented reality method may be implemented in other ways. The wearable device 10 and the construction terminal 20 of the augmented reality system described above are only exemplary. The division of the described modules may be a division according to logic functions, other ways of division may exist during actual implementation. For example, a plurality of modules may be combined or integrated into another system, or some features may be omitted or not executed. Furthermore, the coupling or communication connection among the modules may be via some ports, or may be electrical or other forms.

As components of the augmented reality system, the above functional modules may or may not be physical blocks. The modules may be disposed at one position or may be distributed over a plurality of network units. The modules may be implemented either by means of hardware (e.g., the display module 23 can be a screen), or by means of software functional blocks. Those skilled in the art may choose some or all of those modules to attain a solution according to actual needs. In addition, the construction terminal may use a computer as an example, however, the construction module is not limited to a computer and may be any terminal with the capability to construct a 3D virtual model, including a laptop, a PDA (Personal Digital Assistant), etc., or even a wearable device itself.

In summary, pictures of an object to be virtualized may be taken via a wearable device from a plurality of angles, based on which a 3D virtual model of the object to be virtualized may be constructed. The initial profile dimension of the 3D virtual model may be modified to obtain a target profile dimension. The 3D virtual model, having the target profile dimension, may be overlaid to a selected real scenario, such that a user may be able to freely and conveniently modify the dimension of the 3D virtual model according to personal preferences, and better overlay the 3D model onto a real scenario, which may improve an effect of Augmented Reality and may have a relatively low cost. Moreover, the use of a wearable device may take pictures to construct a 3D virtual model of an object to be virtualized that may result in easy operations, that may be fashionable, and that may facilitate promotion of the use thereof.

It should be noted again that only examples of the present invention are described above, and the scope of the present invention, as defined by the appending claims, is not limited thereby. Any equivalent structure or equivalent flow change based on the specification and drawings shall all be encompassed by the scope of the appending claims.

1. A wearable device-based augmented reality method, wherein the method comprises:
taking pictures of an object to be virtualized via a wearable device from a plurality of angles;
according to the pictures from a plurality of angles;
constructing a 3D virtual model of the object to be virtualized, wherein the 3D virtual model includes an initial profile dimension;
modifying the initial profile dimension of the 3D virtual model to obtain a target profile dimension of the 3D virtual model;
overlaying the 3D virtual model having the target profile dimension to a selected real scenario to obtain a virtual and real integrated image, wherein a plurality of real scenarios to be selected are displayed in a thumbnail format for selection;
providing a preview option and a saving option;
when the preview option is selected, displaying a current virtual and real integrated image in real time; and
when the saving option is selected, saving the current virtual and real integrated image.

2. The method according to claim 1, wherein modifying the initial profile dimension of the 3D virtual model comprises:
selecting a similar point of the pictures from a plurality of angles, and obtaining a real dimension of the object to be virtualized by simultaneously considering the depth parameters of the pictures from a plurality of angles; and
modifying the initial profile dimension of the 3D virtual model according to the real dimension.

3. The method according to claim 1, wherein modifying the initial profile dimension of the 3D virtual model comprises:
selecting, through a preset database, a corresponding 3D virtual model of the object to be virtualized in the database; and
modifying the initial profile dimension of the constructed 3D virtual model according to a dimension of the selected 3D virtual model in the database.

4. A wearable device-based augmented reality method, wherein the method comprises:
taking pictures of an object to be virtualized via a wearable device from a plurality of angles;
according to the pictures from a plurality of angles, constructing a 3D virtual model of the object to be virtualized, wherein the 3D virtual model includes an initial profile dimension;
modifying the initial profile dimension of the 3D virtual model to obtain a target profile dimension of the 3D virtual model; and
overlaying a 3D virtual model having the target profile dimension to a selected real scenario to obtain a virtual and real integrated image.

5. The method according to claim 4, wherein modifying the initial profile dimension of the 3D virtual model comprises:
selecting a similar point of the pictures from a plurality of angles, and obtaining a real dimension of the object to be virtualized by simultaneously considering the depth parameters of the pictures from a plurality of angles; and
modifying the initial profile dimension of the 3D virtual model according to the real dimension.

6. The method according to claim 4, wherein the step of modifying the initial profile dimension of the 3D virtual model comprises:
selecting, through a preset database, a corresponding 3D virtual model of the object to be virtualized in the database; and
modifying the initial profile dimension of the constructed 3D virtual model according to a dimension of the selected 3D virtual model in the database.

7. The method according to claim 4, wherein the method further comprises:
displaying a plurality of real scenarios to be selected in a thumbnail format.

8. The method according to claim 4, wherein the method further comprises:
providing a preview option and a saving option;
when the preview option is selected, displaying a current virtual and real integrated image in real time; and
when the saving option is selected, saving the current virtual and real integrated image.

9. An augmented reality system, comprising: a wearable device and a construction terminal, wherein the wearable device includes a shooting module and a transmission module, and wherein the construction terminal includes a receiving module, a processing module and a display module, wherein:
the shooting module is configured to take pictures of an object to be virtualized from a plurality of angles, and the transmission module is configured to transmit the pictures from a plurality of angles to the receiving module;
the processing module is configured to construct a 3D virtual model of the object to be virtualized according to the pictures from a plurality of angles received by the receiving module, wherein the 3D virtual model includes an initial profile dimension; and
the processing module is further configured to modify the initial profile dimension of the 3D virtual model to obtain a target profile dimension of the 3D virtual model, to overlay a 3D virtual model having the target profile dimension to a selected real scenario to obtain a virtual and real integrated image, and further to control the display module to display the virtual and real integrated image.

10. The system according to claim 9, wherein the processing module is further configured to select a similar point of the pictures from a plurality of angles, obtain a real dimension of the object to be virtualized by simultaneously considering the depth parameters of the pictures from a plurality of angles, and modify the initial profile dimension of the 3D virtual model according to the real dimension.

11. The system according to claim 9, wherein the processing module is configured to select, through a preset database, a corresponding 3D virtual model of the object to be virtualized in the database, and modify the initial profile dimension of the constructed 3D virtual model according to a dimension of the selected 3D virtual model in the database.

12. The system according to claim 9, wherein the processing module is further configured to control the display module to display a plurality of real scenarios to be selected in a thumbnail format.

13. The system according to claim 9, wherein the processing module is further configured to provide a preview option and a saving option and, when the preview option is selected, control the display module to display a current virtual and real integrated image in real time, and when the saving option is selected, save the current virtual and real integrated image.

14. The method according to claim 1, wherein the method further comprises:
providing a preview option and, when the preview option is selected, displaying a current virtual and real integrated image in real time.

15. The method according to claim 1, wherein the method further comprises:
providing a saving option and, when the saving option is selected, saving a current virtual and real integrated image.

16. The method according to claim 4, wherein the method further comprises:
providing a preview option and, when the preview option is selected, displaying a current virtual and real integrated image in real time.

17. The method according to claim 4, wherein the method further comprises:
providing a saving option and, when the saving option is selected, saving a current virtual and real integrated image.

18. The system according to claim 9, wherein the processing module further comprises:
a preview option and, when the preview option is selected, displaying a current virtual and real integrated image in real time.

19. The system according to claim 9, wherein the processing module further comprises:
a saving option and, when the saving option is selected, saving a current virtual and real integrated image.

20. The system according to claim 9, wherein the processing module is further configured to obtain a real dimension of the object to be virtualized and modify the initial profile dimension of the 3D virtual model according to the real dimension.
